(19) United States
(12) Patent Application Publication
(10) Pub. No.: US 2003/0101074 A1
(43) Pub. Date: May 29, 2003

(54) System and method for evaluating real estate and the surrounding environment and visualizing the evaluation results

(76) Inventors: Takeshi Suzuki, Kitagun (JP); Yu Meng, Bronx, NY (US)

Correspondence Address: Yu Meng, Apt 6E, 3200 Netherland Ave., Bronx, NY, 10463, US

(21) Appl. No.: 10/304,510

(22) Filed: Nov. 26, 2002

Related U.S. Application Data
(60) Provisional application No. 60/338,551, filed on Nov. 29, 2001.

(51) Int. Cl. G06F 17/60

(52) U.S. Cl. 705/1; 705/10

(57) ABSTRACT

The system and method of the invention provide objective evaluation of real estate and the surrounding environment, and produce graphical presentation of the evaluation results. Information about real estate and the surrounding environment is stored in a database cluster. Users can set Weighting Factors of their own choosing for all characteristics included in the evaluation process. Based on the information in the database cluster and users' preferences, evaluations are performed for both real estate and the surrounding environment. The evaluation results are superimposed on Satellite Space Images and/or Digitized Maps.

This invention relates to a system and method of evaluating real estate and the surrounding environment, and producing graphical presentations of the evaluation results.

An old and famous maxim in real estate is “location, location, location.” The maxim tells us that the most important thing about real estate is its geographical location, i.e. its environment. Existing real-estate information systems emphasize only the characteristics of real estate, but never include environmental factors connected with that real estate.

A primary objective in the real-estate sales industry is to place high quality and appropriate real-estate property information in the hands of buyers, quickly and inexpensively. The so-called Multiple Listing Service (MLS) has been in use in the real-estate sales industry for a number of years. MLS is typically used by real-estate agents searching for homes on behalf of clients. The MLS relies upon an agent-generated list of homes for sale, which is stored in a database.

The MLS publishes a printed magazine containing written descriptions and still photographs of real-estate properties that are for sale. The MLS also provides an on-line video-presentation service that enables buyers to view still photographs of properties and to access details of these properties in written form on a video monitor. Buyers who enter the marketplace have the opportunity to consult the MLS as a preliminary step in making a match between the buyers' needs and those properties that are currently available for sale. While the MLS system is a great improvement over earlier systems, it has many faults and problems. Although the MLS fulfills the need for providing information about real-estate properties in particular locations relatively quickly and inexpensively, it does not provide environmental information. Furthermore, the search method will not produce useful results if the operators do not have intricate knowledge of specific areas, including their informal housing-tract designations and the environment.

The buyers must travel to the sites of prospective properties in order to obtain information about the most important environmental factors accounting for most purchase decisions.

Because of the distances involved, clients wishing to relocate to another city generally must fly to the destination city weeks in advance and scout out a location, a task that often requires driving around in a strange city under stringent time constraints.

With the present invention, information about real estate and the surrounding environment is already stored in the database; thus, users don't need prior knowledge of specific areas before starting their searches.

With prior real-estate systems, potential real-estate buyers have to eliminate some geographic areas by themselves before performing their searches; doing so requires knowledge about specific areas. For example, if users want to live near a big city, they must have knowledge of population distribution. Otherwise, they may get many listings of properties in rural areas in their search results. Therefore, they must indicate specific geographic areas in which they are interested before they can start searching. With the present invention, because environmental factors are included in the evaluation and search conditions, potential real-estate buyers may search for real estate with certain conditions without indicating a geographic location. The customized conditions specified by the users will eliminate automatically all real estate that doesn't meet the users' conditions.

The definition of real estate is property in buildings and land. Most prior real-estate evaluation systems emphasize evaluation of buildings according to building characteristics. When real estate is land, there are fewer characteristics to consider, and the surrounding environment becomes a critical evaluation factor.

There is no prior real-estate evaluation system that considers environmental factors. The prior systems can not evaluate a location where there is no real estate. The present invention considers many environmental factors in evaluating real estate, and it can calculate an Evaluation Score of any location. Thus, it can generate maps for graphical displaying of evaluation results. The graphical presentations make it much easier for users to get a concrete impression about real estate, including not only about specific buildings, but also about the surrounding areas.

In the prior real-estate information systems, although nothing seems to exist in either common practice or in the literature relative to the present invention, the following references are of interest:

Tornetta, U.S. Pat. No. 5,032,989, shows a method for locating available real-estate properties for sale, lease or rental using a database of available properties at a central location and remote stations which use a graphic interface to select desired regions on a map of the areas of interest. Information about the properties can then be obtained in textual form. The method does not evaluate real estate. And users need to select desired regions on a map of the areas of interest.

Janssen, U.S. Pat. No. 5,754,850, provides a method and apparatus for searching for homes in a search pool for exact and close matches according to primary and non-primary selection criteria. For both primary and non-primary features, if an item in a database is an exact match to a given search feature, then that item is assigned full points. If an item closely satisfies the search feature, then that item is assigned full or partial points. The method includes only characteristics of real-estate properties in the search.

Cheetham et al, U.S. Pat. No. 6,178,406, shows a computer-implemented method for estimating the price of real property such as a single family residence. They provide a method that determines whether specified prices on real property interests are reasonable. In their price validation process, they include only characteristics of real-estate properties, such as number of bedrooms, bathrooms, and fireplaces.

None of the prior real-estate evaluation systems mention environmental factors. None of the evaluation systems provide graphical presentations for their evaluation results.

### BRIEF SUMMARY OF THE INVENTION

It is an object of the invention to evaluate real estate and the surrounding environment by not only the real-estate characteristics, but also the characteristics of the surrounding environment, such as residents'-profile information, natural-environment information, and social-environment information.

It is another object of the invention to provide graphical presentations of the evaluation results superimposed on Satellite Images and/or Digitized Maps.

Briefly, the present invention relates to a system and method for storing real-estate characteristics, environmental characteristics, Satellite Images and/or Digitized Maps in a database cluster.

Given the users' requests, the system determines comparative values of comparable properties by combining and comparing real-estate and environmental characteristics to ultimately determine evaluation values for particular locations.

The evaluation conditions can be customized. Users can choose those real-estate and environmental factors that are important to them and assign different weights to those factors, depending on the relative importance of each.

Users with complex real-estate and environmental requirements can evaluate and search real estate remotely even without prior knowledge of specific areas.

By superimposing the evaluation results on Satellite Images and/or Digitized Maps, the system enables users to visualize the evaluation results. Users can get a concrete impression of the results and understand them easily and precisely.

In general, the present invention provides a system and method of evaluating real estate, including the surrounding environment, and produces graphical presentations of the evaluation results.

The above and other objects and advantages of the invention will become more readily apparent when reference is made to the description in conjunction with the accompanying drawings.

### BRIEF DESCRIPTION OF THE DRAWINGS

FIG. 1 is an overall block diagram of a system typical of the present invention.

FIG. 2A is a block diagram of the Real Estate Database in the Database Cluster shown in FIG. 1.

FIG. 2B is a block diagram of the Residents' Profile Database in the Database Cluster shown in FIG. 1.

FIG. 2C is a block diagram of the Natural Environment Database in the Database Cluster shown in FIG. 1.

FIG. 2D is a block diagram of the Social Environment Database in the Database Cluster shown in FIG. 1.

FIG. 3A is a depiction of search results superimposed on Satellite Images and/or Digitized Maps displayed on a monitor.

FIG. 3B is a depiction of a map of evaluation results superimposed on Satellite Images and/or Digitized Maps displayed on a monitor.

FIG. 4 is a flow chart illustrating the procedure in the Input and Display Module shown in FIG. 1.

FIG. 5A is a flow chart illustrating the evaluation operations of the Evaluation and Search Module shown in FIG. 1.

FIG. 5B is a flow chart illustrating the search operations of the Evaluation and Search Module shown in FIG. 1.

FIG. 6 is a flow chart illustrating the calculation of the Evaluation Score for one location.

### DETAILED DESCRIPTION OF THE INVENTION

Glossary of Terminology

Satellite Space Image

An image photographed by satellite from space, usually stored as bit-mapped graphics

Satellite Image

An abbreviation for “Satellite Space Image”

Digitized Map

Map data showing administrative districts, transportation routes, and landmarks, usually stored as vector graphics

Database Cluster

A group of complementary databases that provide information about real estate and the surrounding environment, Satellite Images, and/or Digitized Maps

Host System

The computer system used in the present invention, which contains a database cluster and several process-control modules

Data Transmission Lines

Lines used in a communications network (preferably the Internet) to connect users and the Host System

Characteristic Score

A score represents quantitative evaluation of a real-estate characteristic or the surrounding environment characteristic

Evaluation Score

A score represents quantitative evaluation of the real estate or the surrounding environment

Weighting Factor

A percentage that reflects the relative importance to users of each real-estate or environment characteristic, to be used in the calculation of the overall Evaluation Scores

Search Threshold

A value of the Evaluation Score that represents a specific user's minimum requirements for a search

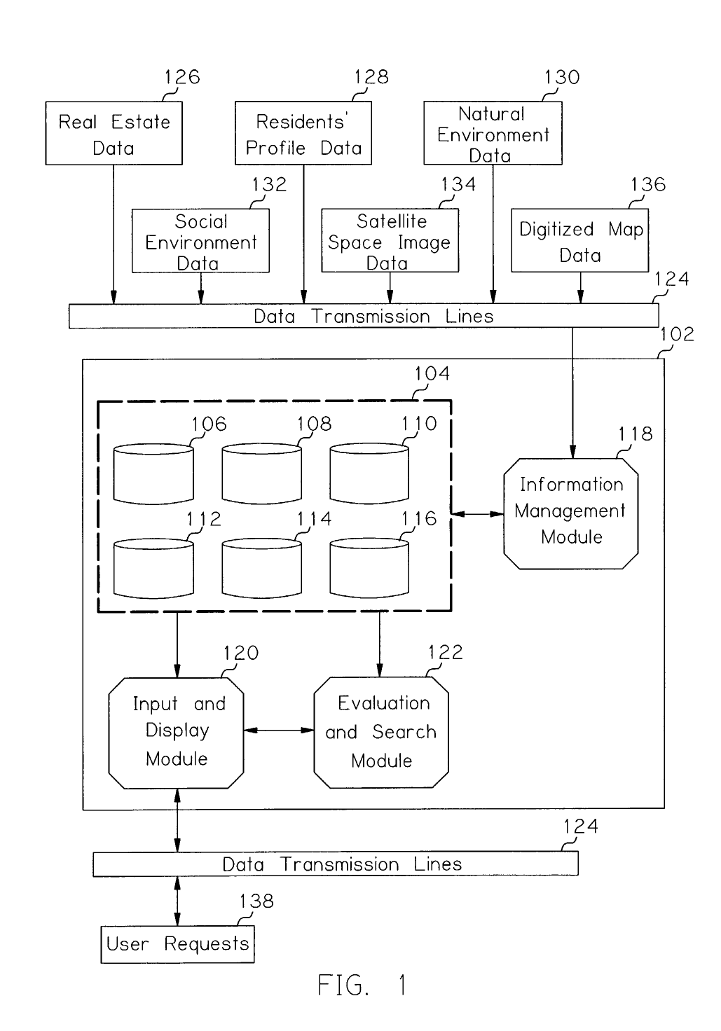

In the drawings, FIG. 1 is an overall block diagram of a system typical of the present invention.

In this system, a Host System 102 contains a Database Cluster 104, Information Management Module 118, Input and Display Module 120, and Evaluation and Search Module 122.

The Host System 102 exchanges data with users and system administrators through Data Transmission Lines 124.

The Database Cluster 104 consists of Real Estate Database 106, Residents' Profile Database 108, Natural Environment Database 110, Social Environment Database 112, Satellite Space Image Database 114, and/or Digitized Map Database 116.

The Information Management Module 118 controls the data input; input data include Real Estate Data 126, Residents' Profile Data 128, Natural Environment Data 130, Social Environment Data 132, Satellite Space Image Data 134, and/or Digitized Map Data 136.

The Input and Display Module 120 provides a user interface to User Requests 138.

The Evaluation and Search Module 122 calculates Evaluation Scores and performs searches based on users' conditions.

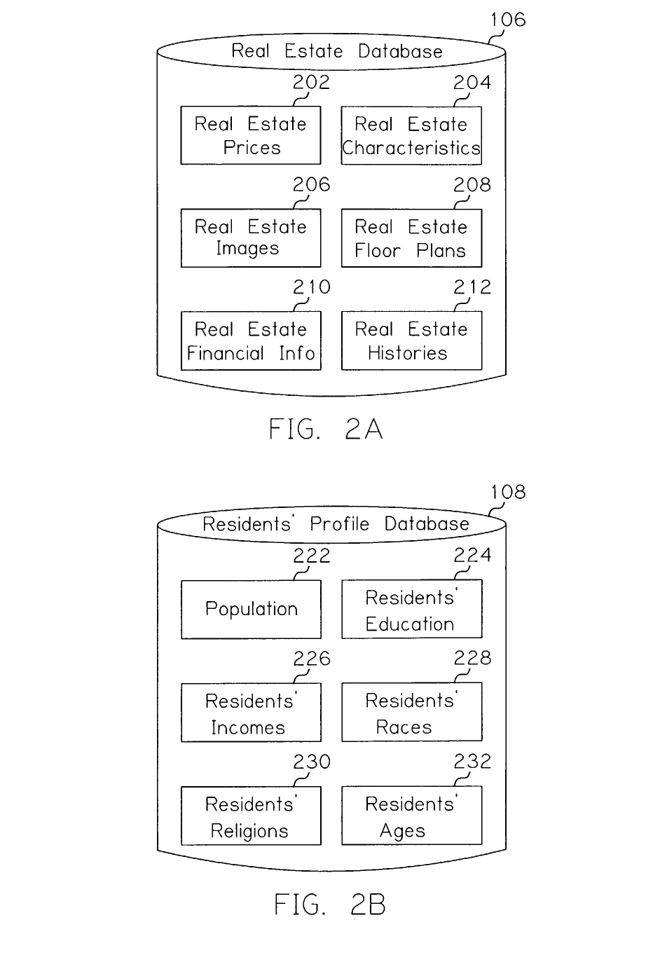

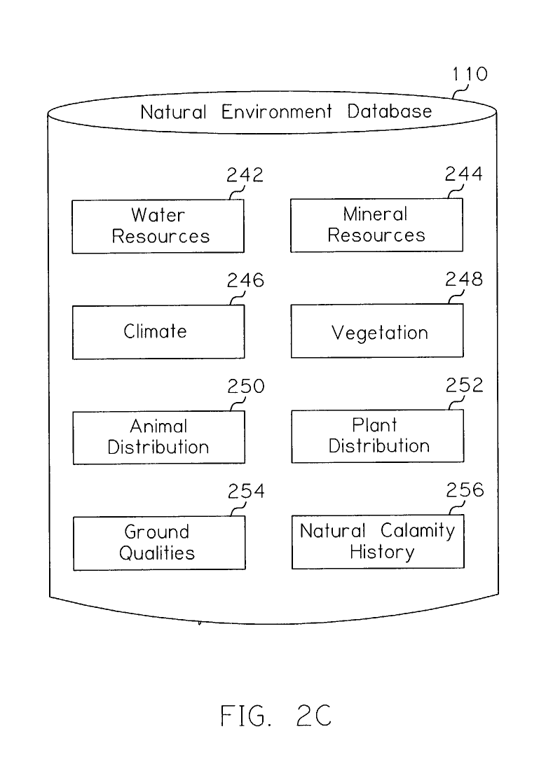

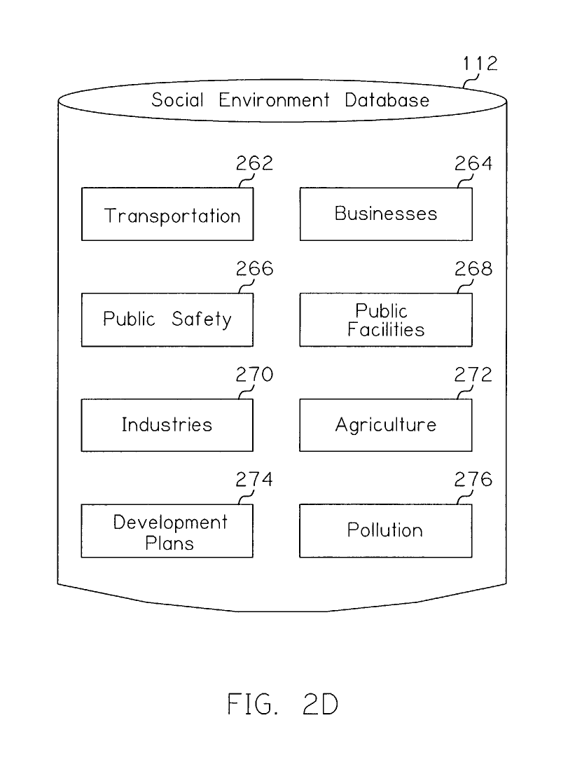

FIG. 2A is a block diagram of the Real Estate Database 106 in the Database Cluster 104 shown in FIG. 1.

The Real Estate Database 106 consists of information about Real Estate Prices 202, Real Estate Characteristics 204, Real Estate Images 206, Real Estate Floor Plans 208, Real Estate Financial Info 210, and/or Real Estate Histories 212.

FIG. 2B is a block diagram of the Residents' Profile Database 108 in the Database Cluster 104 shown in FIG. 1.

The Residents' Profile Database 108 consists of information about Population 222, Residents' Education 224, Residents' Incomes 226, Residents' Races 228, Residents' Religions 230, and/or Residents' Ages 232.

FIG. 2C is a block diagram of the Natural Environment Database 110 in the Database Cluster 104 shown in FIG. 1.

The Natural Environment Database 110 consists of information about Water Resources 242, Mineral Resources 244, Climate 246, Vegetation 248, Animal Distribution 250, Plant Distribution 252, Ground Qualities 254, and/or Natural Calamity History 256.

FIG. 2D is a block diagram of the Social Environment Database 112 in the Database Cluster 104 shown in FIG. 1.

The Social Environment Database 112 consists of information about Transportation 262, Businesses 264, Public Safety 266, Public Facilities 268, Industries 270, Agriculture 272, Development Plans 274, and/or Pollution 276.

Transportation 262 consists of information about airports, railroads, subways, buses, ferries, highways and streets, parking areas, and/or traffic volume.

Businesses 264 consists of information about retail stores, enterprises, and/or job information.

Public Safety 266 consists of information about crime rates, police stations, fire departments, dangerous areas, and/or refuge locations.

Public Facilities 268 consists of information about cultural institutions, educational institutions, parks, hospitals, recreational facilities, sports facilities, and/or public service facilities.

Industries 270 consists of information about types of industries and/or numbers of employees.

Agriculture 272 consists of information about types of agricultural products.

Development Plans 274 consists of information about development plans for housing, transportation, public facilities, businesses, and/or industries.

Pollution 276 consists of information about pollution of underground water, soil, and/or air, including noise.

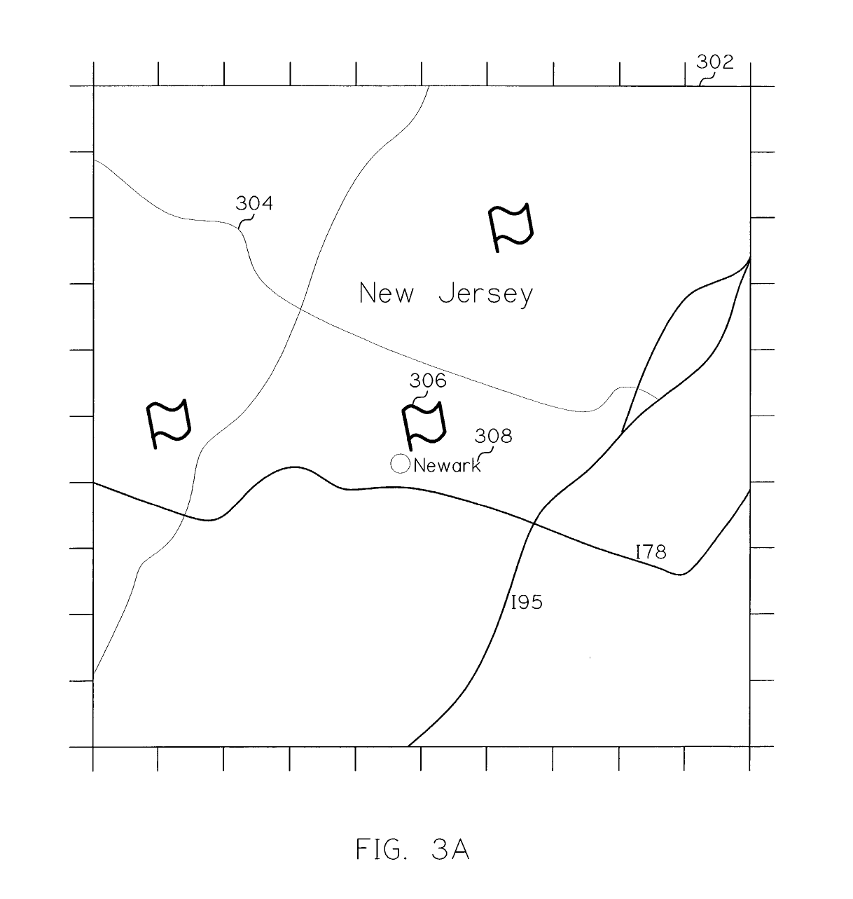

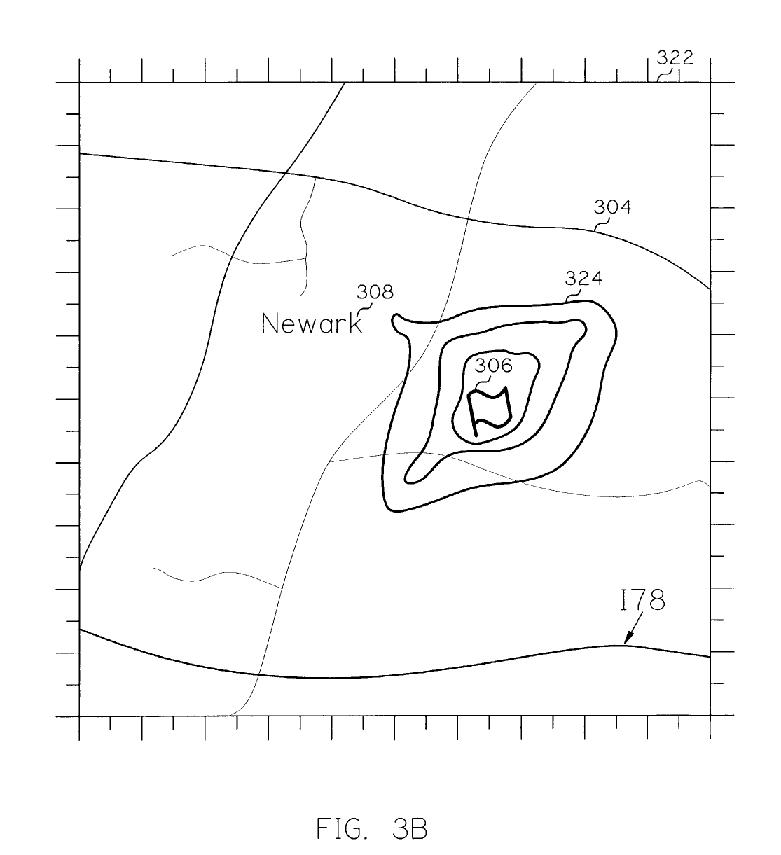

FIG. 3A is a depiction of search results superimposed on Satellite Images and/or Digitized Maps displayed on a monitor.

The search results are shown within a scaled area 302. The Satellite Images and/or Digitized Maps 304 are shown on the background accompanied with Text Descriptions 308. The locations that have satisfied the search conditions are marked with Marks 306. Here, the marks are flags.

FIG. 3B is a depiction of a map of evaluation results superimposed on Satellite Images and/or Digitized Maps displayed on a monitor.

The evaluation results are shown within a scaled area 322. The Satellite Images and/or Digitized Maps 304 are shown on the background accompanied with Text Descriptions 308. The location that is selected is marked with Mark 306; here, the mark is a flag. The Evaluation Scores are shown with histogram, color and/or Contour Lines 324; here, contour lines are used.

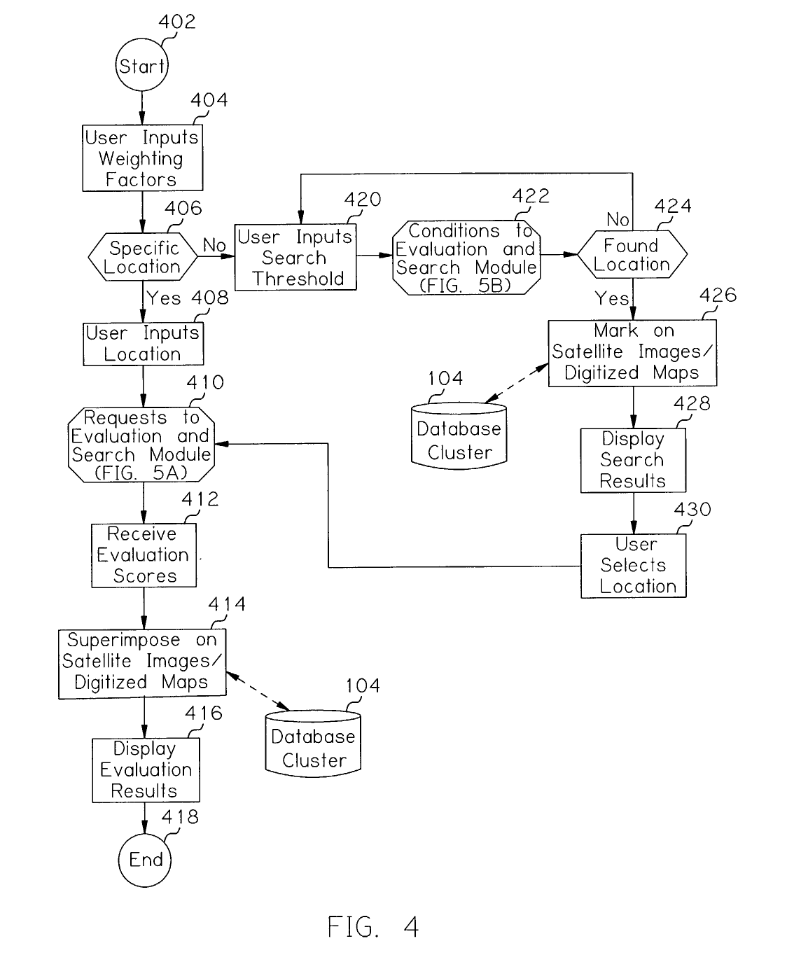

FIG. 4 is a flow chart illustrating the procedure in the Input and Display Module 120 shown in FIG. 1.

Processing begins at Start block 402 and proceeds to block 404, which receives Weighting Factors from User Requests 138 shown in FIG. 1.

Decision block 406 determines whether the user has specified a location. If the user has, the program receives the location at block 408.

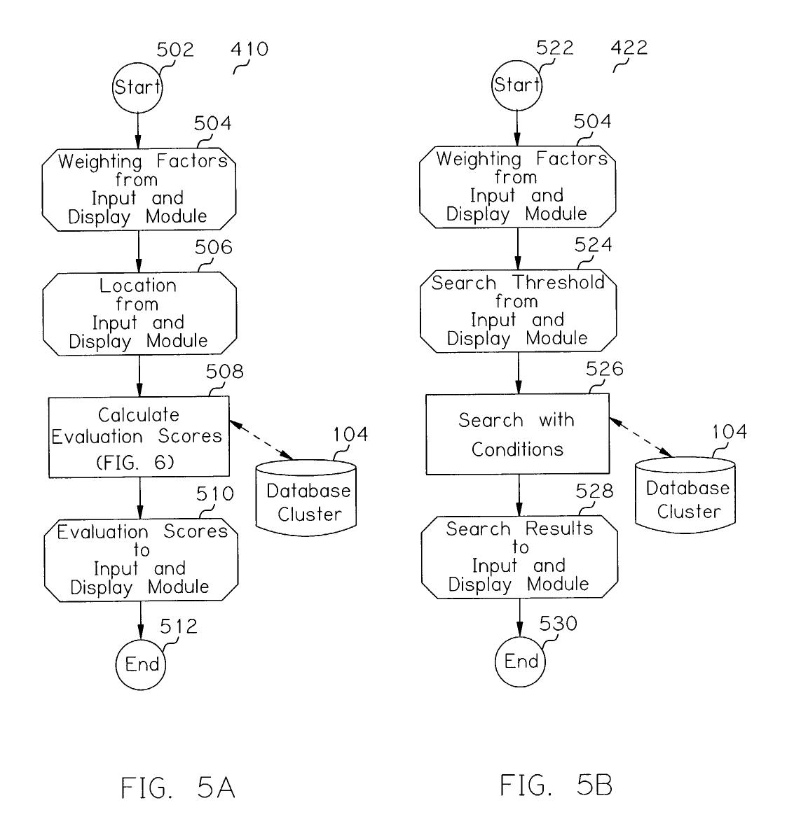

When the user has specified a location, processing goes to block 410. Details of the procedure in block 410 are illustrated in FIG. 5A, in which the Evaluation and Search Module 122 receives Weighting Factors and location information and evaluates real estate and the surrounding environment.

After the evaluation, the program receives the Evaluation Scores at block 412.

Block 414 accesses the Database Cluster 104, uploads Satellite Images and/or Digitized Maps and superimposes the Evaluation Scores on them.

Processing continues at block 416, where the superimposed results are displayed to the user. A depiction of the superimposed results is shown in FIG. 3B.

Processing terminates at End block 418.

When the user has not specified location, processing proceeds to block 420, which receives a Search Threshold from User Requests 138 shown in FIG. 1.

Processing proceeds to block 422. Details of the procedure in block 422 are illustrated in FIG. 5B, in which the Evaluation and Search Module 122 receives Weighting Factors and Search Threshold information and searches locations.

Decision block 424 determines whether the Evaluation and Search Module 122 found any location. If not, the processing returns to block 420 and asks the user to reenter the Search Threshold. If any location is found, the processing accesses the Database Cluster 104, uploads Satellite Images and/or Digitized Maps and marks search results at block 426. A depiction of the search results is shown in FIG. 3A.

After displaying the search results at block 428, the program asks the user to select a location at block 430; it then goes to block 410, where the Evaluation and Search Module 122 evaluates real estate and the surrounding environment.

FIG. 5A is a flow chart illustrating the evaluation operations of the Evaluation and Search Module 122 shown in FIG. 1.

Processing begins at Start block 502 and proceeds to block 504, which receives Weighting Factors from the Input and Display Module 120. In addition, the program receives a location at block 506 from the Input and Display Module 120.

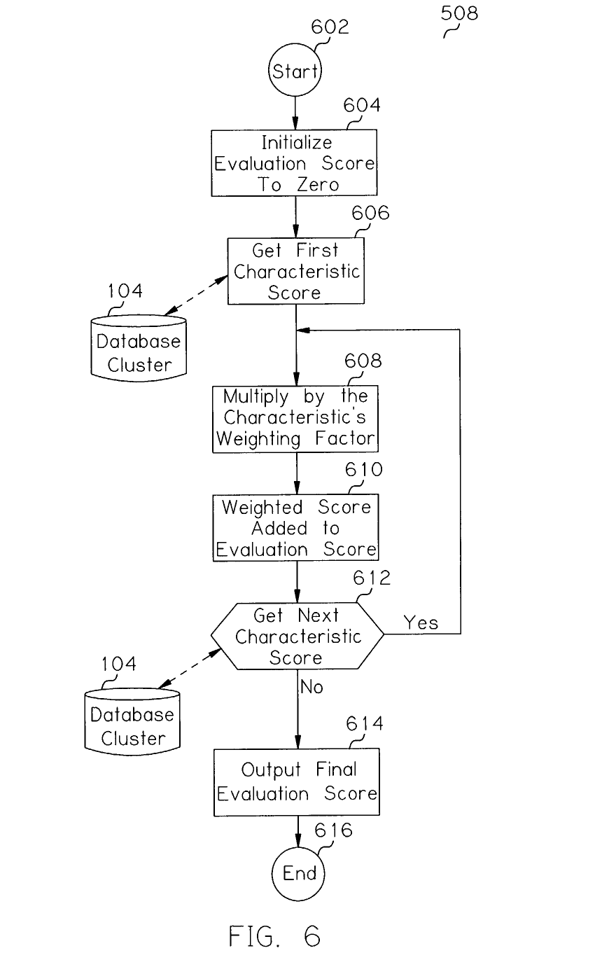

The program accesses the Database Cluster 104, and calculates Evaluation Scores at block 508. Details of the procedure in block 508 are illustrated in FIG. 6.

Processing passes the Evaluation Scores to the Input and Display Module 120 at block 510 and terminates at End block 512.

FIG. 5B is a flow chart illustrating the search operations of the Evaluation and Search Module 122 shown in FIG. 1.

Processing begins at Start block 522 and proceeds to block 504, which receives Weighting Factors from the Input and Display Module 120. In addition, the program receives the Search Threshold at block 524 from the Input and Display Module 120.

The program accesses the Database Cluster 104 and then performs searches at block 526. All Evaluation Scores that are below the Search Threshold are discarded.

The program passes the search results to the Input and Display Module 120 at block 528 and terminates at End block 530.

FIG. 6 is a flow chart illustrating the calculation of the Evaluation Score for one location.

The user must specify at least one characteristic of real estate or environment in order to start the evaluation.

Processing begins at Start block 602 and proceeds to block 604, which initializes the Evaluation Score to zero.

At block 606, the program accesses the Database Cluster 104 and gets the first Characteristic Score.

At block 608, the Characteristic Score for the real-estate or environment characteristic is multiplied by the Weighting Factor for that characteristic. The generated result is called a weighted score for that characteristic. The weighted score for the characteristic is added to the Evaluation Score to generate an intermediate result at block 610.

The program accesses the Database Cluster 104 and tries to get the next Characteristic Score at block 612.

If the program can get the next Characteristic Score, it goes to block 608 and repeats the calculation just as indicated above. If the program can not get the next Characteristic Score, it outputs the final Evaluation Score at block 614 and terminates at End block 616.

Thus, the weighted scores for all characteristics are added together to obtain a final Evaluation Score for one location.

Advantages

From the description above, a number of advantages of the present invention become evident:

(a) By including real-estate environment factors during the evaluation, it provides much more information for evaluating real estate than prior real-estate evaluation systems.

(b) Users can customize their evaluations by setting their preferred Weighting Factors.

(c) It generates a map of the evaluation results, showing not only real estate but also the surrounding environment.

(d) The map of the evaluation results is superimposed on Satellite Images and/or Digitized Maps with a user-friendly graphical interface.

Conclusion and Scope

Accordingly, readers can see that the present invention can be used to evaluate and search real estate and the surrounding environment easily and conveniently. Moreover, the present invention can display evaluation results with a graphical interface that is easy to understand.

Although the present invention has been described in detail, it will be understood that this description is not intended to limit the invention to this embodiment. Instead, it is intended to cover all alternatives, modifications and equivalents as may be included within the spirit and scope of the present invention as defined by the appended claims.

We claim:

1. For use with a computer, a system for evaluating real estate and the surrounding environment, comprising:
a database cluster containing a database storing real-estate information and other databases selected from the group consisting of:
a database storing residents'-profile information,
a database storing natural-environment information,
a database storing social-environment information; and
means for analyzing the information and producing overall Evaluation Scores of real estate and the surrounding environment based upon an evaluation of the information.

2. The system as recited in claim 1 wherein said database storing real-estate information contains information selected from the group consisting of:
real-estate prices,
real-estate characteristics,
real-estate images,
real-estate floor plans,
real-estate financial information,
real-estate histories.

3. The system as recited in claim 1 wherein said database storing residents'-profile information contains information selected from the group consisting of:
population,
residents' education,
residents' incomes,
residents' races,
residents' religions,
residents' ages.

4. The system as recited in claim 1 wherein said database storing natural-environment information contains information selected from the group consisting of:
water resources,
mineral resources,
climate,
vegetation,
animal distribution,
plant distribution,
ground qualities,
natural calamity history.

5. The system as recited in claim 1 wherein said database storing social-environment information contains information selected from the group consisting of:
transportation, including information about at least one of the following: (i) airports, (ii) railroads, (iii) subways, (iv) buses, (v) ferries, (vi) highways and streets, (vii) parking areas, (viii) traffic volume,
businesses, including information about at least one of the following: (i) retail stores, (ii) enterprises, (iii) job information,
public safety, including information about at least one of the following: (i) crime rates, (ii) police stations, (iii) fire departments, (iv) dangerous areas, (v) refuge locations,
public facilities, including information about at least one of the following: (i) cultural institutions, (ii) educational institutions, (iii) parks, (iv) hospitals, (v) recreational facilities, (vi) sports facilities, (vii) public service facilities,
industries, including information about at least one of the following: (i) types of industries, (ii) numbers of employees,
agriculture, including information about types of agricultural products,
development plans, including development information about at least one of the following: (i) housing, (ii) transportation, (iii) public facilities (iv) businesses, (iii) industries,
pollution, including current pollution information about at least one of the following: (i) underground water, (ii) soil, (iii) air, (iv) noise.

6. A computer-implemented method for evaluating real estate and the surrounding environment, comprising the steps of:
storing real-estate information and environmental information in a database, wherein said environmental information is
selected from the group consisting of:
residents'-profile information,
natural-environment information,
social-environment information; and analyzing the information and producing overall Evaluation Scores of real estate and the surrounding environment based upon an evaluation of the information.

7. The method as recited in claim 6 wherein said real-estate information contains information selected from the group consisting of:
real-estate prices,
real-estate characteristics,
real-estate images,
real-estate floor plans,
real-estate financial information,
real-estate histories.

8. The method as recited in claim 6 wherein said residents'-profile information contains information selected from the group consisting of:
population,
residents' education,
residents' incomes,
residents' races,
residents' religions,
residents' ages.

9. The method as recited in claim 6 wherein said natural-environment information contains information selected from the group consisting of:
water resources,
mineral resources,
climate,
vegetation,
animal distribution,
plant distribution,
ground qualities,
natural calamity history.

10. The method as recited in claim 6 wherein said social-environment information contains information selected from the group consisting of:
transportation, including information about at least one of the following: (i) airports, (ii) railroads, (iii) subways, (iv) buses, (v) ferries, (vi) highways and streets, (vii) parking areas, (viii) traffic volume,
businesses, including information about at least one of the following: (i) retail stores, (ii) enterprises, (iii) job information,
public safety, including information about at least one of the following: (i) crime rates, (ii) police stations, (iii) fire departments, (iv) dangerous areas, (v) refuge locations,
public facilities, including information about at least one of the following: (i) cultural institutions, (ii) educational institutions, (iii) parks, (iv) hospitals, (v) recreational facilities, (vi) sports facilities, (vii) public service facilities,
industries, including information about at least one of the following: (i) types of industries, (ii) numbers of employees,
agriculture, including information about types of agricultural products,
development plans, including development information about at least one of the following: (i) housing, (ii) transportation, (iii) public facilities (iv) businesses, (iii) industries,
pollution, including current pollution information about at least one of the following: (i) underground water, (ii) soil, (iii) air, (iv) noise.

11. A visualization system for displaying Evaluation Scores of real estate and the surrounding environment on Satellite Space Images and/or Digitized Maps, comprising:
a database containing said Satellite Space Images and/or said Digitized Maps; and
a program to receive said Evaluation Scores; and
a display module to superimpose said Evaluation Scores on said Satellite Space Images and/or said Digitized Maps.

12. The visualization system as recited in claim 11 wherein said display module is capable of superimposing said Evaluation Scores on said Satellite Space Images and/or said Digitized Maps with signs selected from the group consisting of:
histogram derived from said Evaluation Scores,
colors, corresponding to said Evaluation Scores,
contour lines derived from said Evaluation Scores,
textual descriptions,
symbolic marks.

13. A visualization method for displaying Evaluation Scores of real estate and the surrounding environment on Satellite Space Images and/or Digitized Maps, comprising the steps of:
storing said Satellite Space Images and/or said Digitized Maps in a database; and
retrieving said Satellite Space Images and/or said Digitized Maps from said database; and
receiving said Evaluation Scores; and
superimposing said Evaluation Scores on said Satellite Space Images and/or said Digitized Maps.

14. The visualization method as recited in claim 13 wherein said superimposing means using a method selected from the group consisting of:
histogram displaying, wherein said histogram is derived from said Evaluation Scores,
color superimposition, wherein said colors correspond to said Evaluation Scores,
contour-line drawing, wherein said contour lines are derived from said Evaluation Scores,
textual description writing,
symbolic-mark displaying.
